(19) United States
(12) Patent Application Publication
(10) Pub. No.: US 2013/0116937 A1
(43) Pub. Date: May 9, 2013

(54) SYSTEM AND METHOD FOR DETECTING FAULT CONDITIONS IN A DRIVETRAIN USING TORQUE OSCILLATION DATA

(71) Applicants: Keith Calhoun, Carmel, IN (US); Robert Kiser, Indianapolis, IN (US); Douglas Adams, West Lafayette, IN (US); Kamran Gul, Houston, TX (US); Nate Yoder, San Diego, CA (US); Christopher Bruns, Albuquerque, NM (US); Joseph Yutzy, South Bend, IN (US)

(72) Inventors: Keith Calhoun, Carmel, IN (US); Robert Kiser, Indianapolis, IN (US); Douglas Adams, West Lafayette, IN (US); Kamran Gul, Houston, TX (US); Nate Yoder, San Diego, CA (US); Christopher Bruns, Albuquerque, NM (US); Joseph Yutzy, South Bend, IN (US)

(21) Appl. No.: 13/458,623

(22) Filed: Apr. 27, 2012

Related U.S. Application Data
(63) Continuation of application No. PCT/US2011/055369, filed on Oct. 7, 2011.
(60) Provisional application No. 61/391,570, filed on Oct. 8, 2010.

(51) Int. Cl. G01M 13/02; G06F 17/00

(52) U.S. Cl. CPC G01M 13/02; G06F 17/00
USPC 702/35

(57) ABSTRACT

In one embodiment, a method is provided for detecting a fault condition in a drivetrain, including the steps of monitoring torque oscillations at a location along a drivetrain, and detecting at least one fault condition associated with a drivetrain component by evaluating torque oscillation data acquired during the monitoring. In another embodiment, a system is provided for detecting a fault condition in a drivetrain including a torque sensor coupled to a drivetrain component and configured to measure torque at a location along the drivetrain and to generate a torque oscillation signal corresponding to the measured torque, and a controller configured to receive the torque oscillation signal and evaluate the torque oscillation signal to identify at least one fault condition associated with the drivetrain component.

### CROSS REFERENCE TO RELATED APPLICATIONS

This application claims the benefit of U.S. Provisional Patent Application Ser. No. 61/391,570 filed on Oct. 8, 2010, the contents of which are incorporated herein by reference in their entirety.

### BACKGROUND

The present invention generally relates to systems and methods for detecting fault conditions in a drivetrain, and more particularly relates to systems and methods for detecting fault conditions in a drivetrain using torque oscillation data.

In the wind energy industry, gearbox failures are among the most costly and the most frequent component failures, adding significantly to the operation and maintenance costs over the life cycle of the turbine. Despite significant improvements in the understanding of gear loads and dynamics, even to the point of establishing international standards for design and specifications of wind turbine gearboxes, these components generally fall short of reaching their design life.

Gas turbine engines also incorporate gearboxes. Gearboxes are often desirable to transmit power within a turbine engine in order to reduce the speed of rotating components. For example, a reduction gearbox can be placed in the drive line between a power turbine and a propeller to allow the power turbine to operate at its most efficient speed while the propeller operates at its most efficient speed. Components of gearboxes associated with gas turbine engines, like gearboxes associated with wind turbines, can also suffer unexpectedly diminished life.

### SUMMARY

In general, embodiments of the present invention are directed to systems and methods wherein oscillations in torque are assessed to determine the vitality of components associated with a drivetrain including, by way of example and not limitation, a gearbox having gears and bearings. Gears and bearings are mounted on shafts and create vibrations as they rotate and interact with other components. The interaction that creates vibrations also generates torque oscillations in the shafts. The ability to detect these features is enabled by magnetic torque sensing of the torque oscillations. Damage to gears and bearings changes the response of the interaction between these components and the torque oscillations transmitted to the shaft. The ability to detect and interpret these changes provides information to determine the type of anomalous behavior occurring in the components. Determination of the failure mechanism allows tracking of failure progression, thereby leading to an ability to predict remaining useful life. Failure mechanism analysis may be supported by the use of physics-based models for data assessment. The torque sensor data is compared to what is expected from the physics-based model based on the operating conditions associated with the gathered torque sensor data.

Embodiments of the present invention can provide a diagnostic technique having the ability to detect precursors to faults (i.e., conditions that lead to the initiation of faults) and/or actual faults. The current state of the art suffers from an inability to detect these fault conditions. Therefore, once a fault is detected, there is little time to react. Embodiments of the present invention can thus provide a proactive tool enhancing the life of the engine. Methods according to various embodiments of the present invention may be applied through the monitoring of the torque of any shaft or related component in a drivetrain.

One embodiment of the present invention is directed to a unique method for detecting fault conditions in a drive train. Another embodiment of the present invention is directed to a unique system for detecting fault conditions in a drive train. Further embodiments of the present invention are directed to unique systems and methods for detecting fault conditions drive train using torque oscillation data. Other embodiments include apparatuses, systems, devices, hardware, methods, and combinations thereof for detecting fault conditions in a drive train. Further embodiments, forms, features, aspects, benefits, and advantages of the present invention will become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 is a graph of the shaft torsion experienced during braking, with the graph showing the dynamic, cyclic nature of torque in a wind turbine gearbox.

FIG. 2A is a schematic of a first gear train system.

FIG. 2B is a schematic of a second gear train system that is simplified but dynamically equivalent to the first gear train system shown in FIG. 2A.

FIG. 3 is a perspective view of a gear tooth illustrating gear tooth geometry and approximations.

FIG. 4 is a schematic of a modeling approach.

FIG. 5A is a graph showing a first modal deflection shape.

FIG. 5B is a graph showing a second modal deflection shape.

FIG. 6 is a graph showing frequency response functions, both damped and undamped.

FIG. 7 is a schematic of a model applied in the exemplary embodiment for determining the dynamic transition error associated with the contact force between the gears.

FIG. 8 is a graph showing a rectangular wave approximation for the tooth mesh stiffness, k(t), of both gear meshes in an exemplary gearbox system being modeled.

FIG. 9 is a graph showing a sample of a gear mesh's Dynamic Transmission Error (DTE).

FIG. 10 is a graph showing the forced response simulation of an analytical model with misalignment.

FIG. 11 is a graph of the forced response simulation of an analytical model with misalignment and with a chipped tooth.

FIG. 12 is a perspective view of a test bench.

FIG. 13 is a spectrogram of data associated with the principle dynamics of the test bench system and their variation with speed.

FIG. 14 is a graph of the torque sensor and accelerometer signals.

FIG. 15 includes a pair of graph families marked “a” and “b” that demonstrate the affect of external excitation on the measurement levels.

FIG. 16 shows the mean amplitude of the frequency spectrum of the data plotted against operating speed for normal operation and operation with added external noise.

FIG. 17 is the mean dimensional damage feature for each gear condition tested.

FIG. 18 shows four Mahalanobis distance plots (a-d) generated using half of the healthy data as a baseline case.

FIG. 19 includes four graphs (a-d) of classification plots and boundaries generated using Parzen discriminant analysis to project the data into two dimensions and linear discriminant analysis to classify the projected data.

### DETAILED DESCRIPTION

For purposes of promoting an understanding of the principles of the present invention, reference will now be made to the embodiments illustrated in the drawings, and specific language will be used to describe the same. It will nevertheless be understood that no limitation of the scope of the invention is intended by the illustration and description of certain embodiments of the invention. In addition, any alterations and/or modifications of the illustrated and/or described embodiment(s) are contemplated as being within the scope of the present invention. Further, any other applications of the principles of the invention, as illustrated and/or described herein, as would normally occur to one skilled in the art to which the invention pertains, are contemplated as being within the scope of the present invention.

The present invention, as demonstrated by the exemplary embodiments described below, provides for the identification of precursors to drivetrain faults and gear failures; namely, misalignment and improper lubrication, as well as an investigation of the identification of the actual faults resulting from the precursors including chipped gear teeth and missing gear teeth. It is proposed that these sub-par operating conditions are just as observable, and even, in many cases, more observable through the use of a torque transducer/sensor when compared to the use of accelerometers or other types of sensors. The torque transducer/sensor is shown to be capable of detecting faults in the gear train with the added benefit of insensitivity to external force input that would otherwise influence an accelerometer's translational type measurement, and with the benefit of increased sensitivity to misalignment. A double spur gear reduction test bench may be used to simulate the sub-par operating conditions examined as an exemplary embodiment, and a physics-based analytical model is also developed for validation of the experimental results.

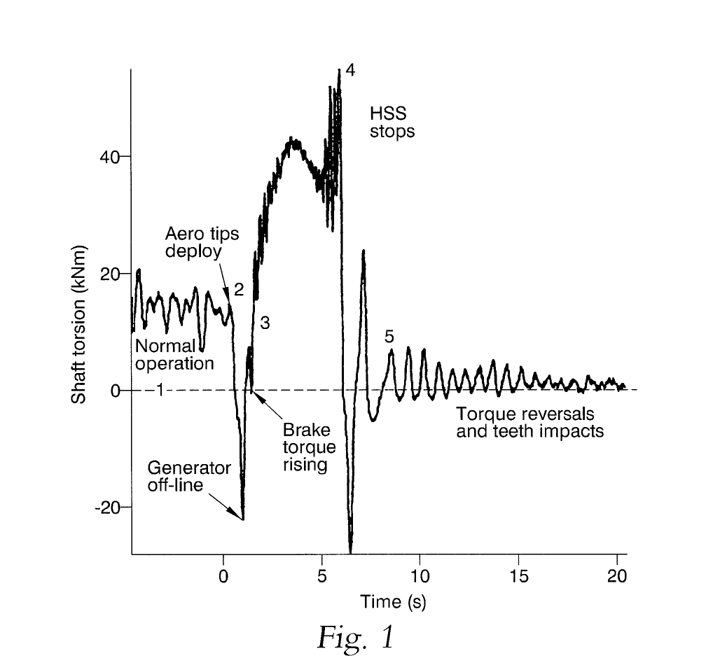

In a significant number of gearbox failures in the wind energy industry, the primary bearing on the low speed shaft experiences faults in its operation, including misalignment and movement of the primary bearing on the mounts. Referring to FIG. 1, illustrated therein is a graph of shaft torsion experienced during braking that shows the dynamic, cyclic nature of torsional vibration in a wind turbine gearbox. To investigate gear health management, a fault detection approach was applied to a test bed involving a spur gear double-reduction transmission, as outfitted with a torque transducer and tri-axial accelerometers on the bearing cases. The test bed is not a wind turbine gearbox in that the gear arrangement is different and the gears are smaller compared to that of a typical wind turbine gearbox. However, the gearbox can serve to test the modeling and fault detection methods proposed herein. Both baseline and faulted measurements are taken from the experimental set-up for data analysis. It has been shown that the torque sensor provides an early indication of fault precursors, such as misalignment between shafts and gears as well as decreased lubrication, while also maintaining the capacity to identify mature faults such as chipped and missing gear teeth. The measurements are analyzed using statistical based methods of analysis; namely, the Mahalanobis distance and Parzen discriminant analysis. These features for fault detection are then characterized at various operating speeds for each of the gear train conditions of interest. An analytical model is created from first principles for verification of results and for simulation of the free and forced dynamics of the overall system.

In one embodiment, a model was developed to numerically describe and simulate the behavior of a gearbox being studied including variations in the gearbox conditions. The exemplary methods used to model the gearbox being studied are described in detail below. Once the model was fully developed, faults such as shaft misalignment and a chipped gear tooth were simulated by varying the model parameters. It should be understood that the methods applied herein can be easily adapted to a wide range of gearbox applications and conditions.

In a further embodiment, the gearbox system was treated as a torsional elastic system consisting of a drive unit, couplings, a torque sensor, shafts, gears, and a brake. All of these components can be described with rotational stiffness parameters and lumped mass moments of inertia. Most of the system components are basic cylindrical shapes, and can therefore be easily modeled. For a cylinder, the rotational stiffness K is determined as follows:

$$K = \frac{T}{θ} = \frac{G ( {I}_{o} - {I}_{i} )}{L} = \frac{π}{2} \frac{G ( {r}_{o}^{4} - {r}_{i}^{4} )}{L}$$

where T is the torque on the cylinder, θ is the rotational deflection of the cylinder, L is the cylinder's length, G is the shear modulus, and I is the polar area moment of inertia given by πr⁴/2 where r is the cylinder radius. Note that the subscripts o and i denote outer and inner radii, respectively, which allow for the calculation to be performed for a hollow cylinder (rᵢ is zero for a solid cylinder). The mass moment of inertia J is determined as follows:

$$J = \frac{π}{2} γ L ( {r}_{o}^{4} - {r}_{i}^{4} )$$

where γ is the density of the cylinder material.

Damping in the gearbox system was also accounted for in the model using stiffness-proportional damping. In most cases of simple rotational systems, stiffness-proportional damping models suffice to model the entire system with reasonable accuracy in terms of response amplitudes. The damping values can then be adjusted by correlating the model results with the experimental data once all other model parameters (inertia and stiffness) are determined.

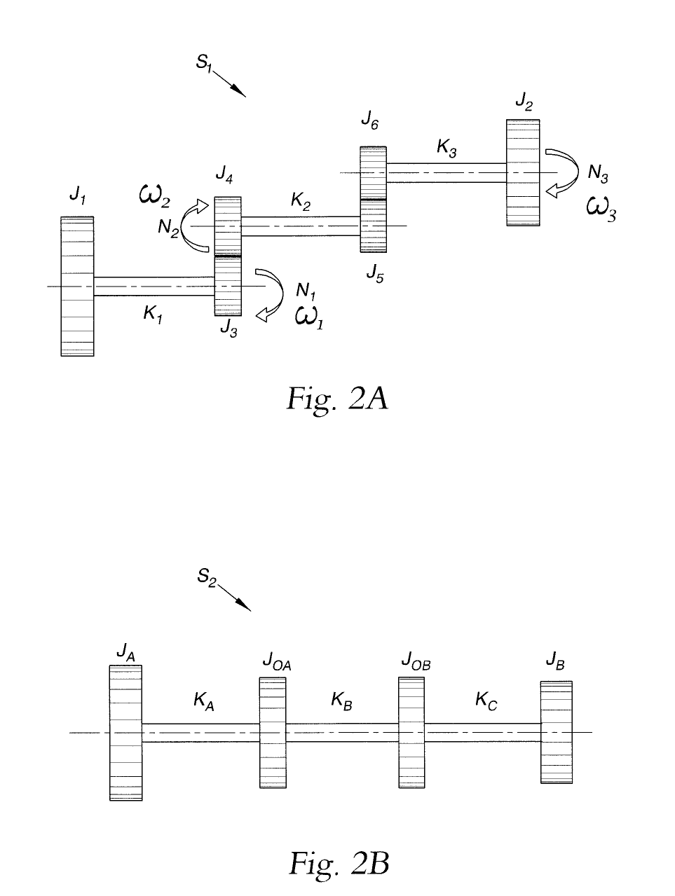

Referring to FIG. 2A, shown therein is a schematic illustration of an exemplary, albeit finite, first gear train system S₁. In the illustrated embodiment, the actual geared transmission system S₁ consists of a series of rotating masses, J₁, J₂, . . . , Jₙ, attached to shafts of torsional stiffness, K₁, K₂, . . . , Kₙ₋₁, geared together with the average mean rotational velocities of the respective shafts and masses, ω₁, ω₂, . . . , ωₙ₋₁, and with the corresponding speed of the shafts N₁, N₂, . . . , Nₙ₋₁ in rpm. However, the determination of torsional response characteristics are much simplified if the actual system is replaced by a dynamically equivalent system. Referring to FIG. 2B, shown therein is a schematic illustration of a dynamically equivalent system S₂ in which all masses and shafts are assumed to rotate at the same speed and with all gear ratios assumed to be 1/1. The following equations apply to both the actual system. S₁ and the equivalent system S₂:

$$Kinetic Energy \text{:} {KE}_{i} = \frac{1}{2} {J}_{i} {ω}_{i}^{2} = \frac{1}{2} {J}_{e} {ω}_{e}^{2} = {KE}_{e}$$

$${J}_{e} \text{/} {J}_{i} = {( {ω}_{i} \text{/} {ω}_{e} )}^{2} = {( {N}_{i} \text{/} {N}_{e} )}^{2}$$

$$Strain Energy \text{:} {P}_{i} = \frac{1}{2} {K}_{i} {θ}_{i} = \frac{1}{2} {K}_{e} {θ}_{e} = {P}_{e}$$

$${K}_{e} \text{/} {K}_{i} = {( {θ}_{i} \text{/} {θ}_{e} )}^{2} = {( {ω}_{i} \text{/} {ω}_{e} )}^{2} = {( {N}_{i} \text{/} {N}_{e} )}^{2}$$

The inertia Jₑ and stiffness Kₑ of each component in the dynamically equivalent system S₂ can be determined with reference to the equivalent system's speed Nₑ. The subscript i refers to the i-th element in the actual system S₁, whereas the subscript e refers to the equivalent element in the dynamically equivalent system S₂. For example, referring to FIGS. 2A and 2B, the equivalent inertias and stiffnesses, with reference to the equivalent system's speed (which was chosen to be Nₑ=N₁) are as follows:

J_{A}=J₁

J_{OA}=J₃+J₄(N₂/N₁)²

J_{OB}=J₅(N₂/N₁)²+J₆(N₃/N₁)²

J_{B}=J₂(N₃/N₁)²

K_{A}=K₁

K_{B}=K₂(N₂/N₁)²

K_{C}=K₃(N₃/N₁)²

Having modeled the simpler cylindrical components and determined their inertias and stiffnesses, the only components that remain to be included in the model are the gears. The inertia of each gear is calculated by assuming the gears are simple cylinders and by using the previously shown equation set forth in paragraph [0035]. However, in order to determine the torsional stiffness of each gear, a more complex model is needed.

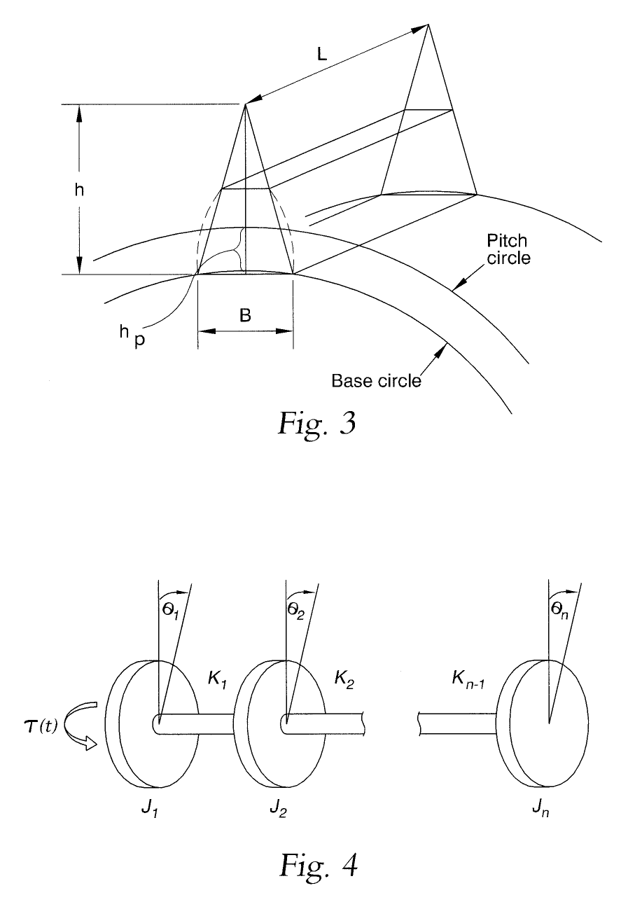

Many approximations of the torsional stiffness of spur gearwheels are available in the literature. For example, FIG. 3 shows a model of gear tooth stiffness that may be used for the system being analyzed. FIG. 3 is attributed to E. J. Nestorides, A Handbook on Torsional Vibration, Cambridge University Press, 1958. The linear compliance of the tooth is derived from the strain energy equation. The end result of the derivation is that the linear stiffness of a gear tooth pair is calculated as follows:

$$\frac{1}{{K}_{L}} = 2 C \frac{12}{EL} {( \frac{h}{B} )}^{3} [ 2.3 {log}_{10} [ \frac{h}{h - {h}_{p}} ] - \frac{{h}_{p}}{h} ( 1 + \frac{{h}_{p}}{2 h} ) ] + … + \frac{{h}_{p}}{GLB ( 1 - {h}_{p} / 2 h )}$$

where the correction factor C is 1.3 for spur gears. The correction factor is applied to account for the depression of the tooth surface at the line of contact and for the deformation in the part of the wheel body adjacent to the tooth. Additionally, E is the modulus of elasticity of the gear, G is the shear modulus, and h, hₚ, B, and L are the gear geometric properties as shown in FIG. 3. The torsional stiffness of the gear tooth pair can then be calculated as follows:

K=2R²K_{L}.

where R is the effective gear radius and K_{L} is the linear tooth stiffness.

Using the techniques described above, the inertia and stiffness parameters of the system components can be modeled. The overall dynamically equivalent system S₂ may have eight (8) degrees of freedom (DOFs), and can be represented via the schematic illustration shown in FIG. 4, where n=8 for the exemplary embodiment of the present invention (as will be discussed in greater detail below, see Table 1). However, it should be understood that the invention is not limited to arrangements with eight components or eight degrees of freedom.

For the modeled system shown in FIG. 4, the inertia and stiffness matrices are derived as follows:

$$[ J ] = [ \begin{matrix}{J}_{1} & 0 & 0 & … & 0 \\ 0 & {J}_{2} & 0 & & ⋮ \\ 0 & 0 & & ⋱ & 0 \\ \text{?} & & ⋱ & {J}_{n - 1} & 0 \\ 0 & 0 & … & 0 & {J}_{n}\end{matrix} ] \\ [ K ] = [ \begin{matrix}{K}_{1} & - {K}_{1} & 0 & 0 & 0 \\ - {K}_{1} & {K}_{1} + {K}_{2} & - {K}_{2} & 0 & 0 \\ 0 & - {K}_{2} & ⋱ & ⋱ & 0 \\ 0 & 0 & ⋱ & {K}_{n - 2} + {K}_{n - 1} & - {K}_{n - 1} \\ 0 & 0 & 0 & - {K}_{n - 1} & {K}_{n - 1}\end{matrix} ]$$

$$\text{?} \text{indicates text missing or illegible when filed}$$

with an overall system of equations of motion (EOM) expressed in matrix-vector form being:

$$[ J ] \{ \ddot{θ} \} + \underbrace{( I + j η ) [ K ]}_{{=}^{Δ} [ \overline{K} ]} \{ θ \} = [ T ( \text{?} ) ]$$

$$\text{?} \text{indicates text missing or illegible when filed}$$

wherein I is an n by n identity matrix and (I+jη)[K] is a complex stiffness matrix appropriate for use in forced torsional response calculations. As previously mentioned, this model consists of a linear discrete torsional system with n=8 DOFs, but it should be understood that this technique could be applied to a wide range of torsional systems and geartrains.

The system components represented by each DOF are listed below in Table 1. In Table 1, the system degrees of freedom (denoted by node numbers 1-8) are cross-referenced with their corresponding system components according to an exemplary embodiment of the present invention:

TABLE 1

| DOF | Corresponding System |
|---|---|
| (Node #) | Component |
| 1 | Motor |
| 2 | Coupling 1 |
| 3 | Torque Sensor |
| 4 | Coupling 2 |
| 5 | Gear Shaft 1 and Gears |
| 6 | Gear Shaft 2 and Gears |
| 7 | Gear Shaft 3 and Gear |
| 8 | Brake |

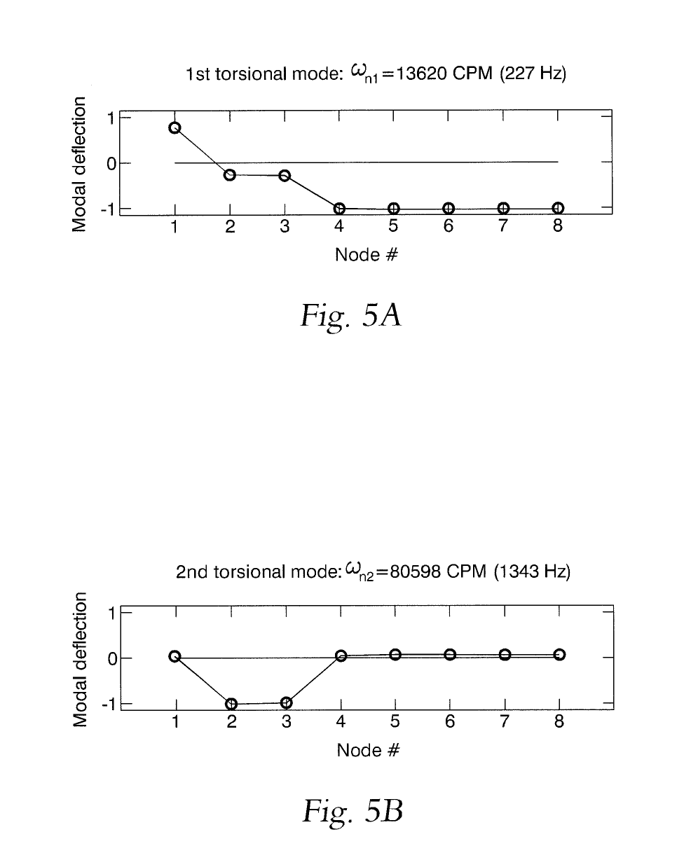

Using modal superposition with the derived system EOMs, the torsional vibration natural frequencies (TNFs) and mode shapes can be determined. The first two modal deflection shapes are shown in FIGS. 5A and 5B, and the TNFs are listed below in Table 2. In Table 2, the torsional natural frequencies are calculated from the lumped parameter model.

TABLE 2

| Flexible | Torsional Natural |
|---|---|
| Mode | Frequency (Hz) |
| 1^{st} | 0 |
| 2^{nd} | 227 |
| 3^{rd} | 1343 |
| 4^{th} | 4439 |
| 5^{th} | 7066 |
| 6^{th} | 8142 |
| 7^{th} | 12299 |
| 8^{th} | 16754 |

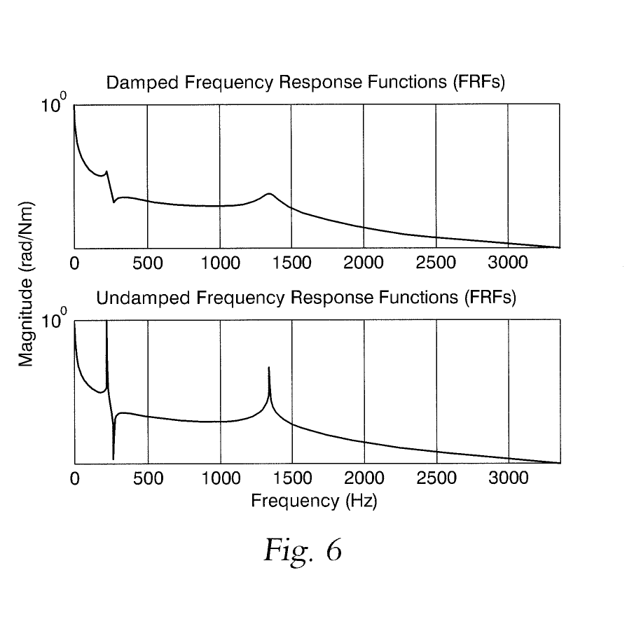

Frequency response functions (FRFs) were computed to analyze the behavior of the first two modes, which are the only modes within a frequency range low enough to be excited by the gearbox system under normal operating conditions. The FRFs were computed using the following equation, the results of which are correspondingly plotted (both damped and undamped) in FIG. 6:

[H(jω)]=[(jω)²[J]+(I+jη)[K]]⁻¹

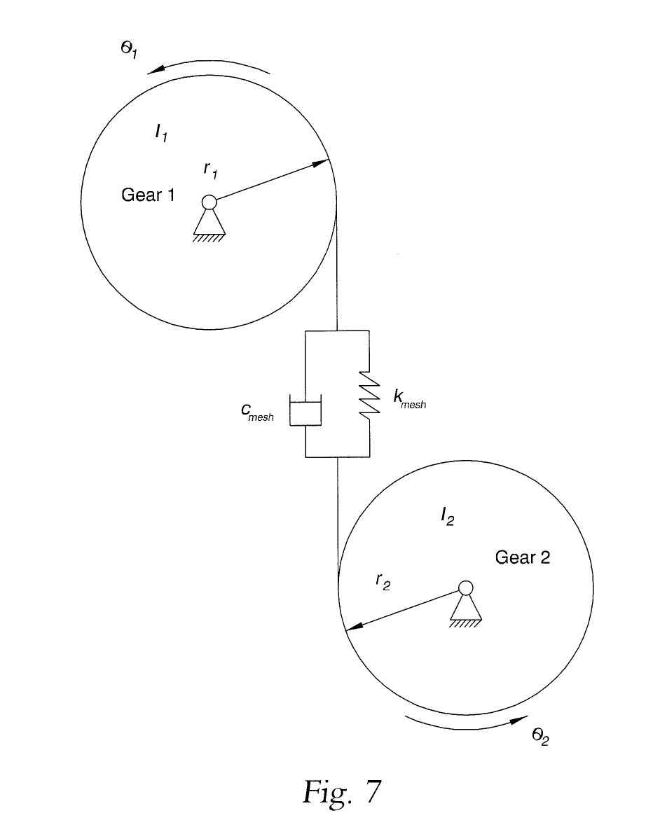

Having calculated the system's natural vibration characteristics, the method according to an exemplary embodiment of the present invention can then include the step of simulating operational conditions. In order to capture the meshing frequency of the gear teeth during operation, it is desirable to consider the parametric vibration characteristics associated with operation of the gears. This analysis involved calculation of the contact force between the gears, which in turn involved the use of dynamic transition error (DTE). Though many complex models exist for this purpose, a single degree of freedom model was chosen for modeling Purposes in the exemplary embodiment. The model chosen for the exemplary embodiment is set forth in R. G. Parker, S. M. Vijayakar, and T. Imajo; Non-linear Dynamic Response of a Spur Gear Pair: Modelling and Experimental Comparisons; Journal of Sound and Vibration 237(3), pp. 435-455, 2000. This model has been tested and proven to be adequate. The schematic of the model used is shown in FIG. 7 which illustrates a single DOF system used to determine the'DTE and contact for the gear tooth mesh contact.

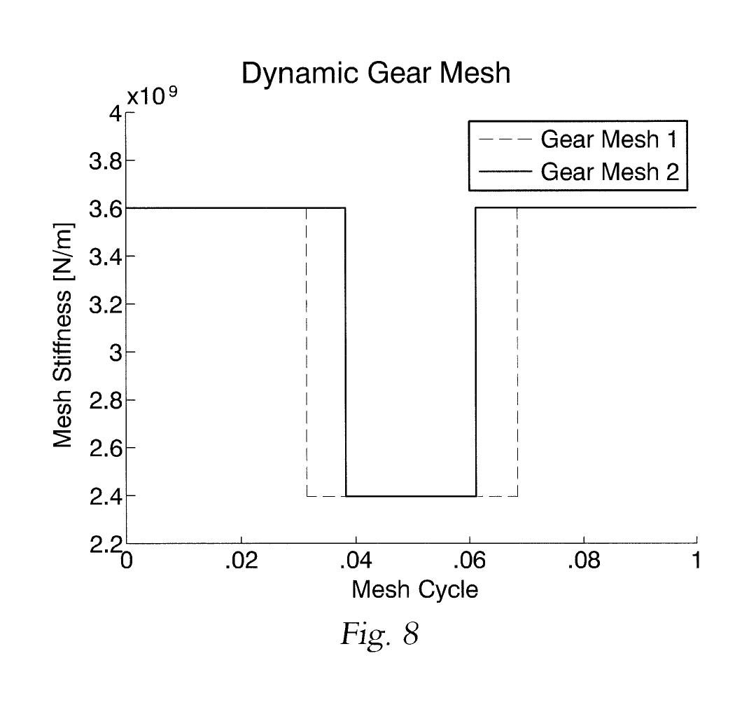

The EOM for this system is as follows:

$$m \ddot{x} + c \dot{x} + F ( t ) = \frac{{T}_{1}}{{r}_{1}} = \frac{{T}_{2}}{{r}_{2}}$$

$$F ( t ) = \{ \begin{matrix}k ( t ) x , & x \geq 0 \\ 0 , & x < 0\end{matrix}$$

where x represents the DTE and x=r₂θ₂+r₁θ₁. The system mass is m=J₁J₂/(J₁r₂²+J₂r₁²), and where T represents the torque transmitted through the system and r represents the radius of the pitch circle of the gear. The function k(t) is the previously calculated linear stiffness (K_{L}) multiplied by the number of gear tooth pairs in contact with, one another. The contact ratio (the average number of teeth in contact throughout a tooth mesh cycle) was used to calculate k(t), which becomes a square wave as shown in FIG. 8. FIG. 8 sets forth a graph showing a rectangular wave approximation for the tooth mesh stiffness k(t) of both gear meshes in the exemplary gearbox system being modeled. Note that the varying width of the 2 teeth portion of the square wave was determined by the different contact ratios of each gear mesh, with the gear mesh 2 having a higher contact ratio and, thus, had 3 tooth pairs in contact for a larger portion of the tooth mesh cycle. The varying mesh stiffness, modeled here as a square wave, is a cause of the time varying nature of the operational dynamics of geared systems.

The EOM for the single DOF tooth mesh model can be calculated using an ordinary differential equation solver in MATLAB that utilizes a fourth-order Runge-Kutta algorithm. Once the EOM is solved, the tooth mesh force can be determined with the following equation where f is the tooth mesh force:

f=cx+kx

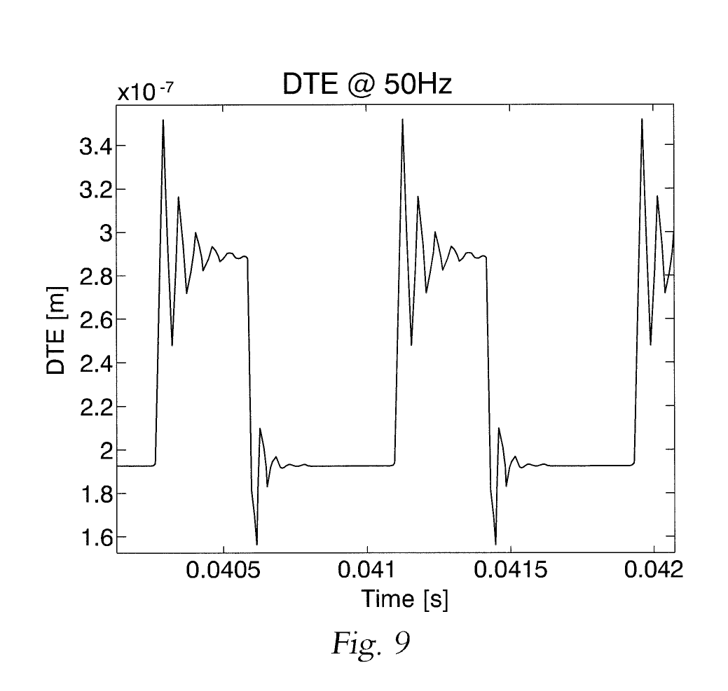

These tooth mesh forces cause torsional vibrations in the system, as demonstrated in the DTE sample illustrated in FIG. 9 which shows a sample of a gear mesh's Dynamic Transmission Error (DTE).

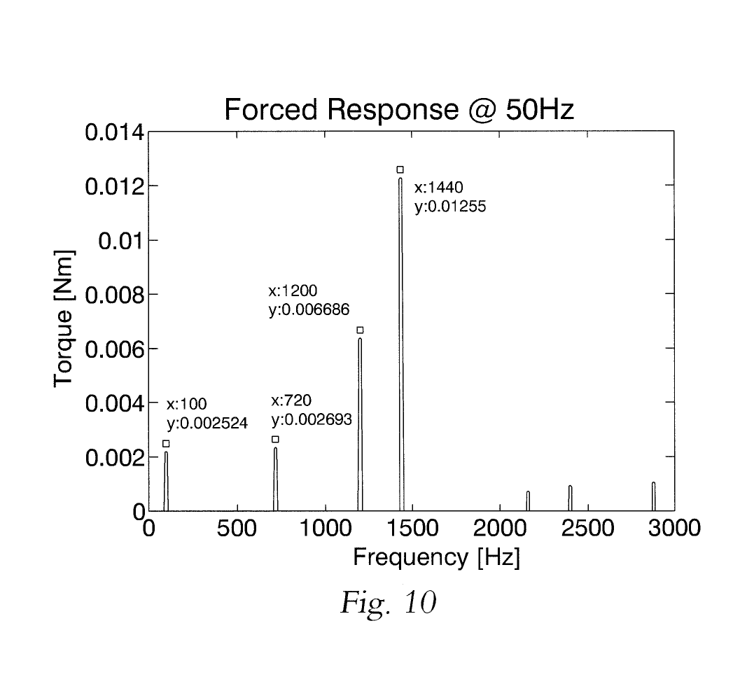

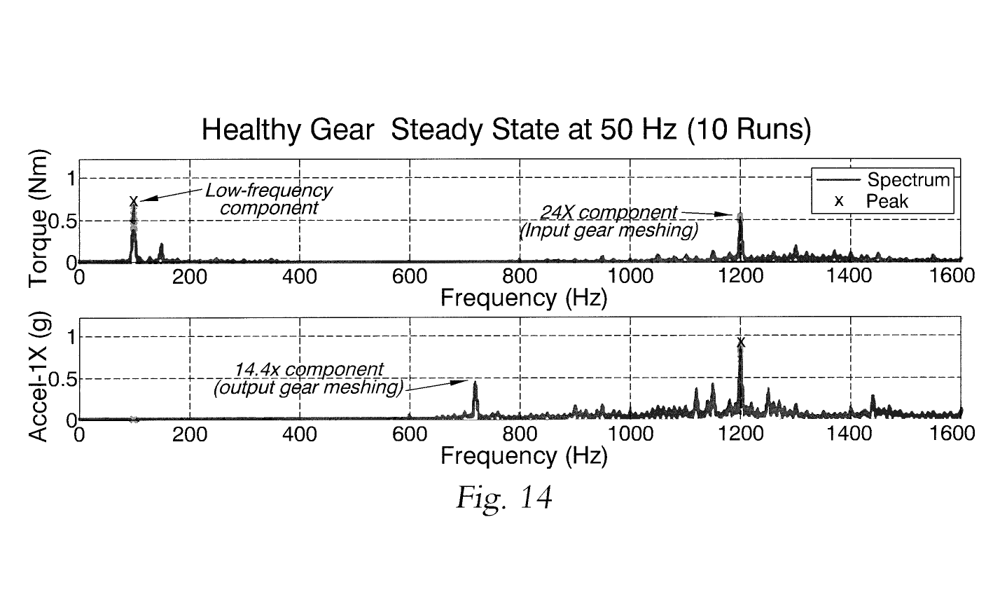

Having modeled the free and forced response of the gearbox according to the exemplary method, faults can be simulated. Thus, the torque measured by the sensor during operation can be simulated, including misalignment simulated at the motor DOF. The resulting spectrum of the simulated torque can be seen in FIG. 10 which shows the forced response simulation of an analytical model with misalignment. Several important peaks were observed in the plotted simulated spectrum of the torque measured by the sensor. The 100 Hz peak is at 2× the operating speed, which is typical in rotational systems and is due to the simulated motor misalignment. Next, at 720 Hz, a peak relating to the 14.4× meshing frequency of the second gear pair can be seen, followed by a peak at 1200 Hz which is the peak corresponding to the 24× meshing frequency of the first gear pair. The remaining peaks are harmonics of the aforementioned peaks. There also exist very small amplitude side bands around the peaks at +/−100 Hz intervals due to the misalignment, but these small amplitude side bands cannot be seen in the linear amplitude plot. The peaks are visible in the experimental data, asp illustrated in FIG. 14 which sets forth a graph of the torque sensor and accelerometer signals, and highlights the torque sensor's high sensitivity to misalignment.

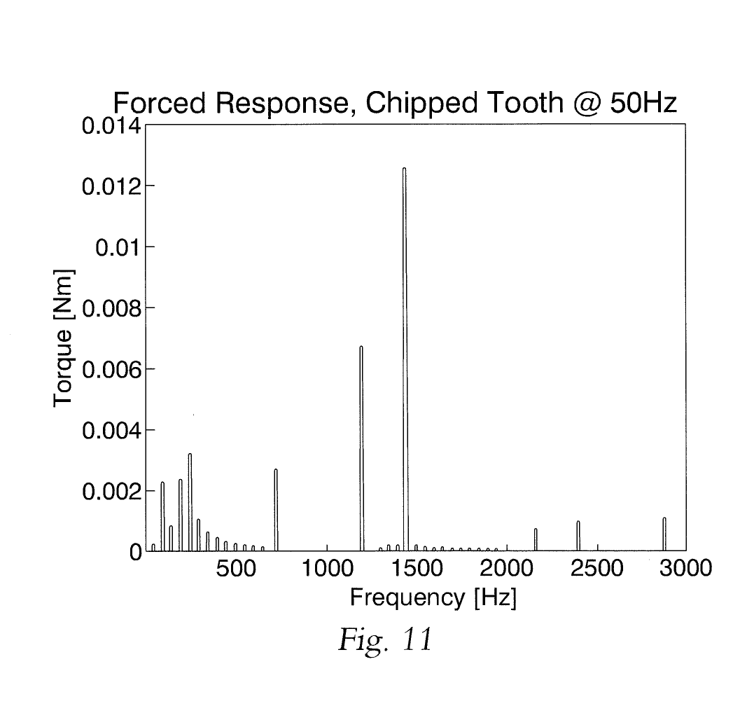

In the exemplary embodiment, it was also of interest to simulate the driveline response for a chipped tooth condition. Specifically, FIG. 11 represents a chipped tooth condition on the first gear (nearest the torque sensor in the drivetrain) in conjunction with misalignment. Specifically, FIG. 11 sets forth a graph of the forced response simulation of an analytical model with misalignment and with a chipped tooth. The chipped tooth was modeled as a 1 per rev decrease in stiffness because a gear's tooth will become less stiff as a portion of its material is removed. This 1 per rev change excited the system's dynamics, which is particularly noted near the first TNF at 227 Hz. These peaks are located at 50 Hz (or 1×) increments.

Several results will be noted from the modeling in the exemplary embodiment of the present invention. First, the location of the natural frequencies of the gearbox that were calculated will tend to play a role in the sensing of the vibrations of the gearbox during testing. The resonances and anti-resonances shown in FIG. 6 will amplify and attenuate responses of the gearbox within certain frequency ranges. Second, the mesh frequencies should be observable in the experimental data as indicated in the model. It is expected that these mesh frequencies will be affected by faults in the gears corresponding to a particular mesh frequency, and thus these mesh frequency peaks will play a role in fault identification. Finally, as shown in the model, the 2× frequency peak and its harmonics will be an indication of misalignment in the gearbox. Overall, the simulation indicated that the torque sensor has the potential to measure the vibrations of the gearbox effectively. These analytical results will be validated in the following sections.

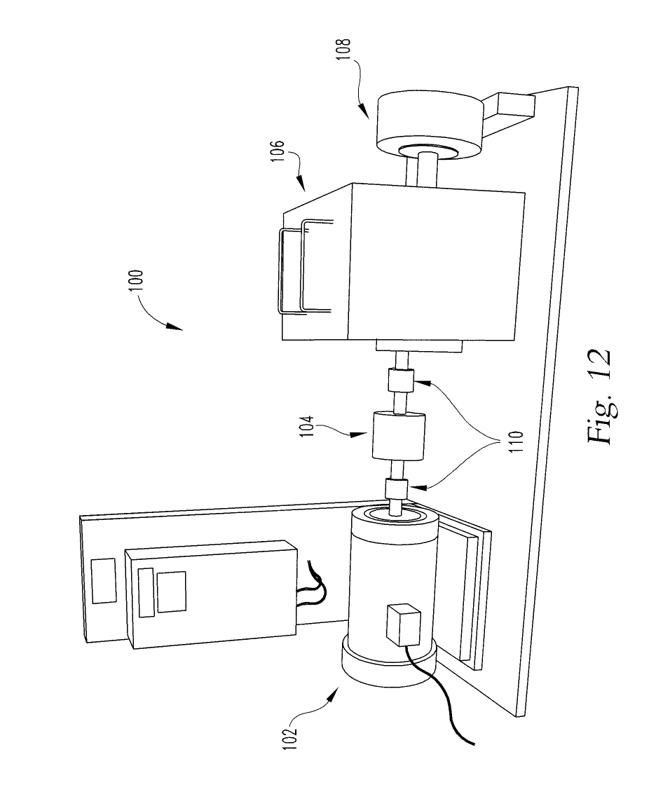

To investigate the prospect of identifying precursors to gear failure using a torque transducer, a test bench manufactured by Spectraquest® termed the Gearbox Dynamics. System (GDS) was used. While this test bench is different in size and gear arrangement compared to other gearboxes, such as a wind turbine gearbox, the test bench can be used to test and validate the modeling techniques already shown and the fault detection techniques which will be discussed below. Referring to FIG. 12, the GDS test bench 100 generally includes a Marathon® Electric D396 electric motor 102, a NCTE model Q4-50 torque sensor (±50 N·m) 104, a two stage, parallel spur gear gearbox 106 including a Martin Sprocket 14½° pressure angle gears of 2, 5, 3, and 4 inch pitch diameter (in drive order for a 5:1 speed reduction, input to output), a Placid Industries magnetic particle brake B220 108, and a pair of couplings 110 that couple the torque sensor 104 with the electric motor 102 and the gearbox 106. The GDS test bench 100 additionally includes two tri-axial PCB accelerometers, model 256A16 (100 mV/g nominal sensitivity). The accelerometers are placed on the outside of the gearbox housing, with one located near the input shaft and the other located near the output shaft. Data is acquired through a controller or computing device; namely, an Agilient E8401A VXI mainframe paired with an E1432A module sampling at 32.768 kHz. For measurement of rotational shaft speed, an optical sensor was placed on the input shaft between the motor and the first coupling.

The first data acquired from the test bench consisted of motor run-up to provide a good overview of the drivetrain and its inherent dynamics. Multiple gear conditions were then introduced to the system for simulating either a faulted condition or a precursor or cause of geartrain failure. Faulted conditions considered included a chipped tooth and a missing tooth, and the precursors considered included misalignment (inherent in the test bench set-up) and lack of lubrication. The gear faults were introduced on the first gear in the drive order (closest to the torque sensor). Additionally, a data set was acquired with the simulation of external noise input through the use of a piezo-electric actuator which was mounted to the gearbox casing. Except for the run-up measurement, steady-state data was collected at 5 Hz motor speed increments ranging from 5-55 Hz.

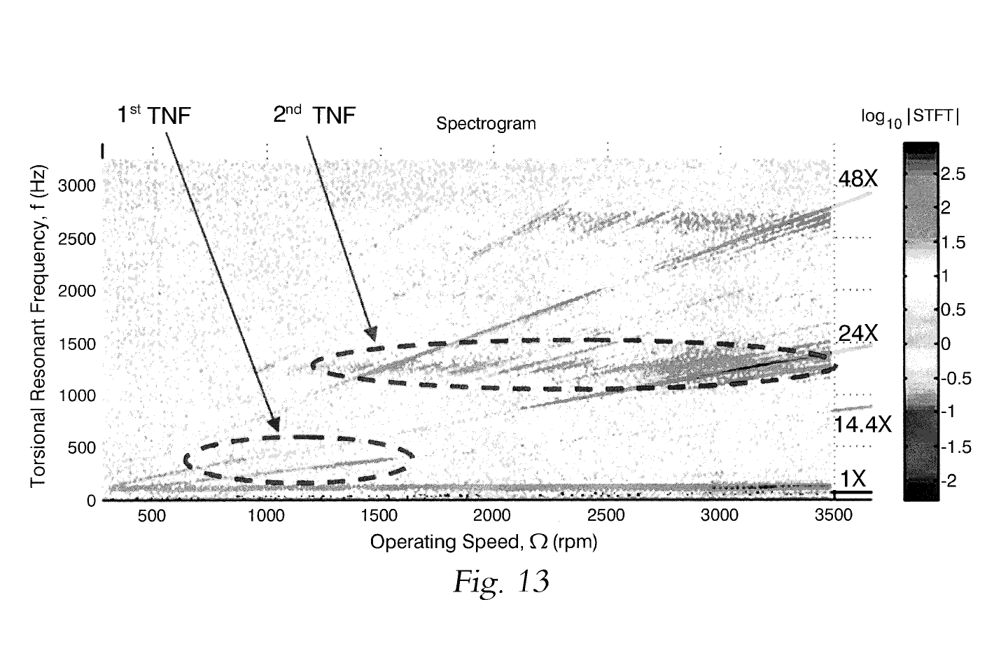

Some validation of the numerical model was sought from the experimentally acquired data. The ramp-up data set was examined to reveal the principle dynamics of the system and to investigate variation with speed. The spectrogram of this data is shown in FIG. 13. FIG. 13 is a spectrogram of speed sweep of the GDS. This process revealed the analytical model's accuracy in predicting the TNFs of the system, and confirms the presence of the first (24×) and second (14.4×) gear mesh frequencies as well as the first harmonic of the first mesh frequency (48×). Unbalance and misalignment (1-2×) are also demonstrated in the experimental data.

Comparison between the accelerometer and torque measurements was also sought to investigate the suitability of the torque transducer in fault detection. As set forth below, Table 3 highlights the lesser variance in the torque data, as compared to the accelerometer, meaning a higher probability of fault detection due to the increased sensitivity to smaller changes. Table 3 also provides a comparison of standard deviation of torque and accelerometer data at 55 Hz.

TABLE 3

| 55 Hz (Healthy | | | | |
|---|---|---|---|---|
| vs. Faulty) | Torque | Accel-X | Accel-Y | Accel-Z |
| Shift in Mean | 0.5624 | −0.0072 | 0.0064 | 0.0988 |
| ( x̅ _{Healthy} [symbol] | (−85.4%) | (−11.0%) | (−12.9%) | (−60.7%) |
| St. dev., | 3.7% of x̅ | 36.2% of x̅ | 10.6% of x̅ | 19.2% of x̅ |
| σ (Healthy) | | | | |
| St. dev., | 21.6% of x̅ | 47.7% of x̅ | 36.1% of x̅ | 50.9% of x̅ |
| σ (Faulty) | | | | |

[symbol]

indicates data missing or illegible when filed

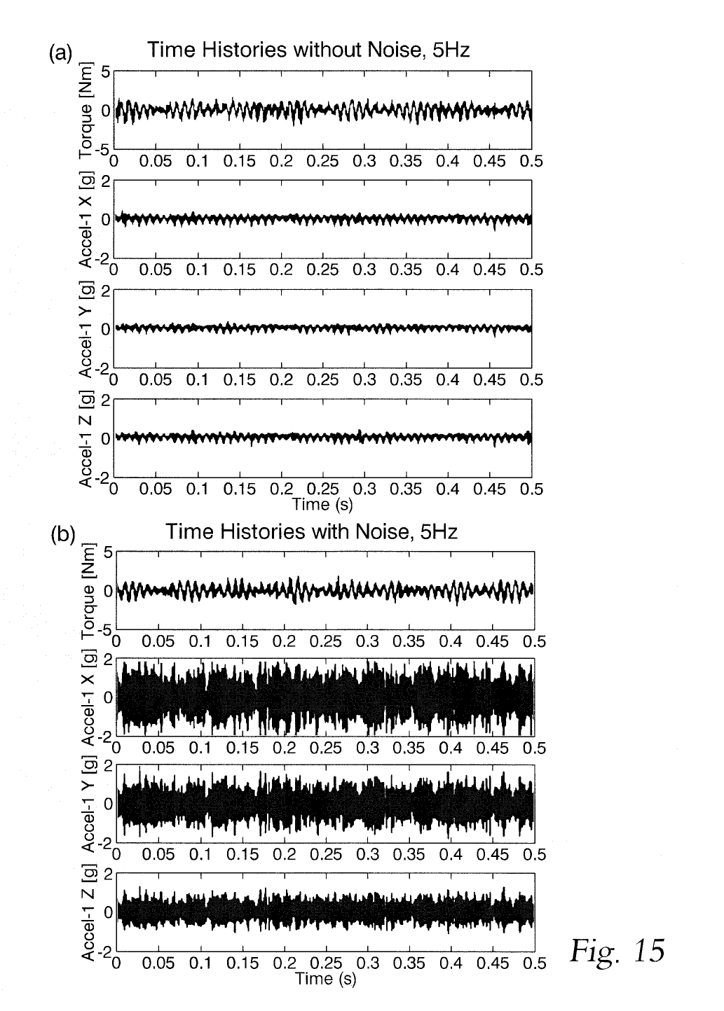

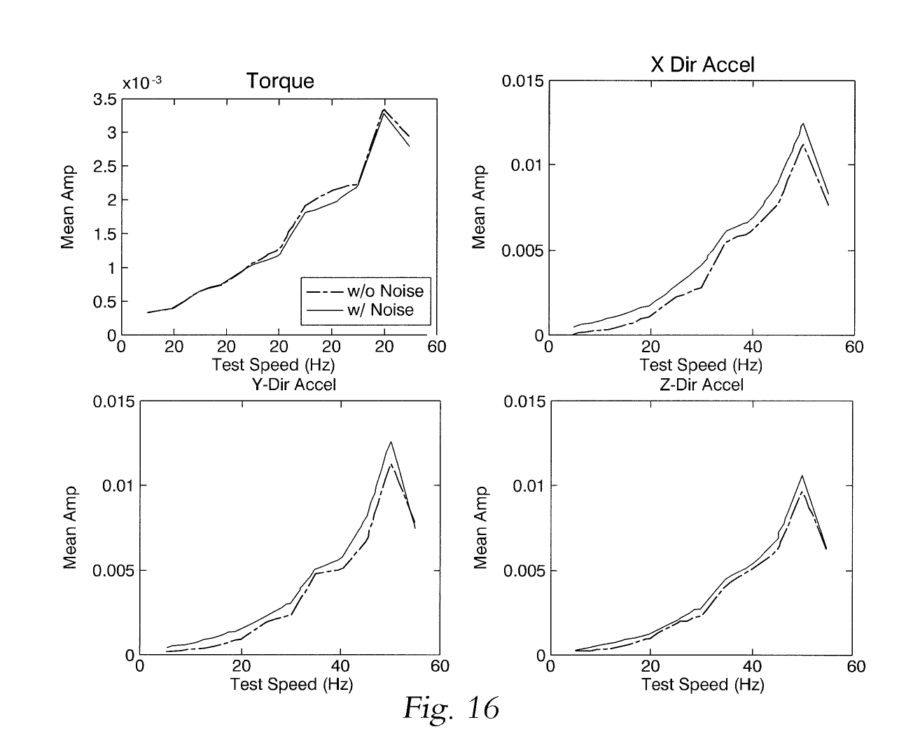

As previously mentioned, the torque data also reveals misalignment in the system. Although the accelerometers were not observed to be as capable of revealing misalignment in the system, the accelerometer data is shown in FIG. 14. Also, the effect of external gearbox noise on the measurements is demonstrated in FIG. 15. In FIG. 15, graph families marked “a” and “b” demonstrate the affect of external excitation on the measurement levels. For this data set, the measurement is presented at a motor speed of 5 Hz because higher operating speeds produce larger amplitudes of response, thereby overshadowing the excitations due to the piezo-electric actuator. This data set makes clear that excitations outside of the torsional system have little to no effect on the measured torsional dynamics, while the accelerometers are greatly affected in their measurement.

The effect of external noise on the torque sensor and accelerometer measurements over all tested operating speeds is summarized in FIG. 16. FIG. 16 shows the mean amplitude of the frequency spectrum of the data plotted against operating speed for normal operation, as well as operation with added external noise. As can be seen in FIG. 16, the mean value of the amplitude of the spectrum of the torque measurements (calculated using the Fast Fourier Transform with synchronously averaged data) is not increased by the added external noise. However, the accelerometer measurements are clearly impacted by the added noise, particularly as the mean amplitude of the frequency content of the accelerometer signals increases due to the added energy input from the piezo-electric actuator. This property is something of consideration when choosing a transducer for an application like a wind turbine gearbox, where many other excitations (e.g., the wind, pitch/yaw actuators, etc.) are exciting the dynamics of the nacelle and surrounding components. Thus, a torque transducer appears to have an advantage over an accelerometer when measuring the dynamics of a rotational system in that the torque transducer is more sensitive to changes in the system (i.e., faults) as well as misalignment, and it appears to be insensitive to structure-born noise. However, in rotational systems, sources of torsional noise also exist, including variations in wind speed on the rotor of a wind turbine. The torque transducer will be affected by this torsional noise but will remain unaffected by translational structure-born noise occurring outside of the rotational system of interest, including varying wind conditions creating vibrations in the nacelle of a wind turbine.

The analysis of the steady-state operational data to identify anomalies in the data began with time synchronous averaging (TSA), which was performed to isolate the gear of interest and to reduce noise. However, during this process it was determined that based upon the tachometer signal, the length of each duration drifted because of slight motor fluctuations. Typically, these variations are accounted for by interpolating the time histories so that they are all of the same length in an attempt to obtain samples that are at a consistent shaft angle. However, this exemplary process inherently assumes a piecewise constant shaft speed every rotation, which in turn results in shaft speed discontinuities. The shaft angle was consequently interpolated using cubic splines in order to obtain physically realizable shaft speed variations. Samples were then taken at constant shaft angles by interpolating the time history with cubic spline functions as well.

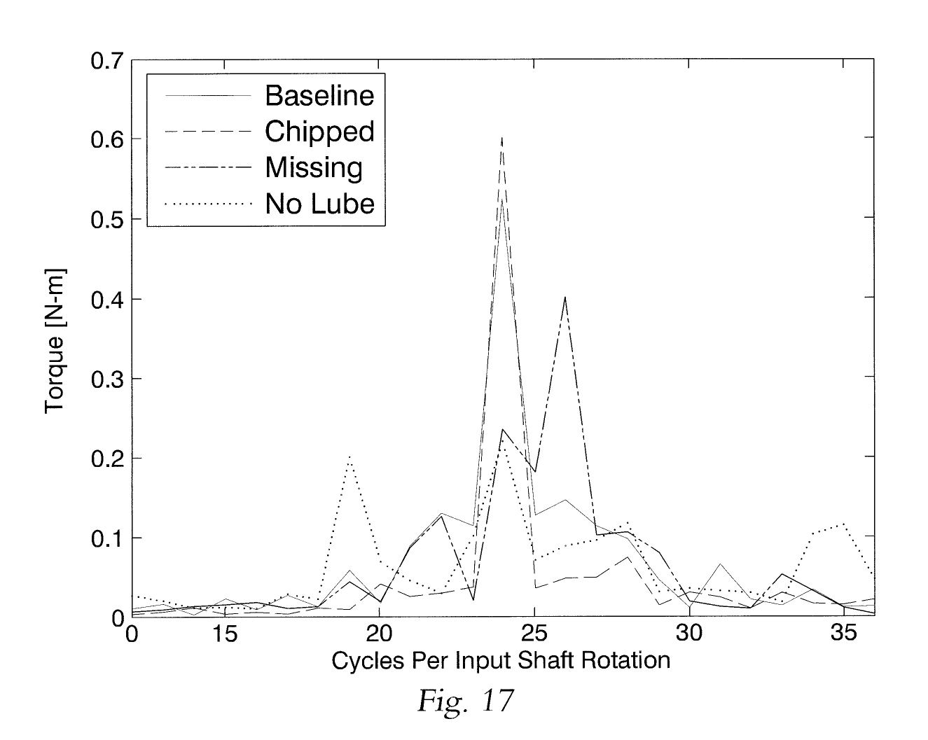

Using this interpolation methodology, TSA was performed based on 24 averages of a single input shaft rotation. To focus the following analyses on the 24 tooth gear on the input shaft, the magnitude of the frequency content of the TSA results at the 24× gear mesh frequency and the next 8 spectral points on either side were used to detect the presence of damage, thereby resulting in a 17 dimensional damage feature vector. As mentioned in the analytical model section, the gear mesh frequency is expected to be significantly affected by faults in the gear corresponding to that particular mesh frequency (in this case the 24 tooth gear), and the surrounding 8 spectral points on either side will capture modulation of the fault in the surrounding frequencies. The mean 17 dimensional damage feature for each gear condition tested at an operating speed of 50 Hz is shown in FIG. 17.

As expected, the main peak occurs at the center spectral component, which corresponds to the 24× gear mesh frequency. However, this peak shifts for the missing tooth condition due to the gear mesh being interrupted once per gear revolution by the missing tooth. The no lube condition results in increased noise in the torque signal, so the gear mesh frequency is not as defined and more modulation occurs. The baseline and chipped conditions are very similar with the exception that the baseline (or healthy) condition has higher amplitudes in the spectral components surrounding the gear mesh frequency. Similar patterns were seen in the damage features at other operating speeds as well.

Each 17 dimensional damage feature vector was standardized by subtracting the mean and dividing by the standard deviation of the training data across each dimension. After calculating the standardized damage feature, an initial statistical analysis was conducted to investigate the feasibility of using the torque signal to detect when the system was no longer operating in the normal condition. To accomplish this task without the use of data from the damaged conditions, the Mahalanobis distance was used (see Staszewski et al., 1997). The Mahalanobis distance for a point xₖ is calculated using the following equation:

d²(xₖ)=(xₖ−μ)^{T}Σ⁻¹(xₖ−μ)

where μ is the sample mean and Σ is the sample covariance matrix, both of which are calculated using only the baseline data. Essentially, the Mahalanobis distance is a weighted measure of similarity that takes the correlations between variables in the baseline data set into account by using the first and second sample moments.

To set a detection threshold without the use of testing data, the mean and standard deviation of the Mahalanobis distances for the baseline data set were calculated. Because the distribution of the variables is very likely non-normal, the threshold was set at the mean of the Mahalanobis distances plus ten standard deviations. By Chebyshev's inequality (See A. Papoulis and S. U. Pillai; Probability, Random Variables and Stochastic Processes; McGraw-Hill. 2002), this means that regardless of the distribution from which this data comes, there is less than a 1% chance of data from this distribution being larger than the threshold.

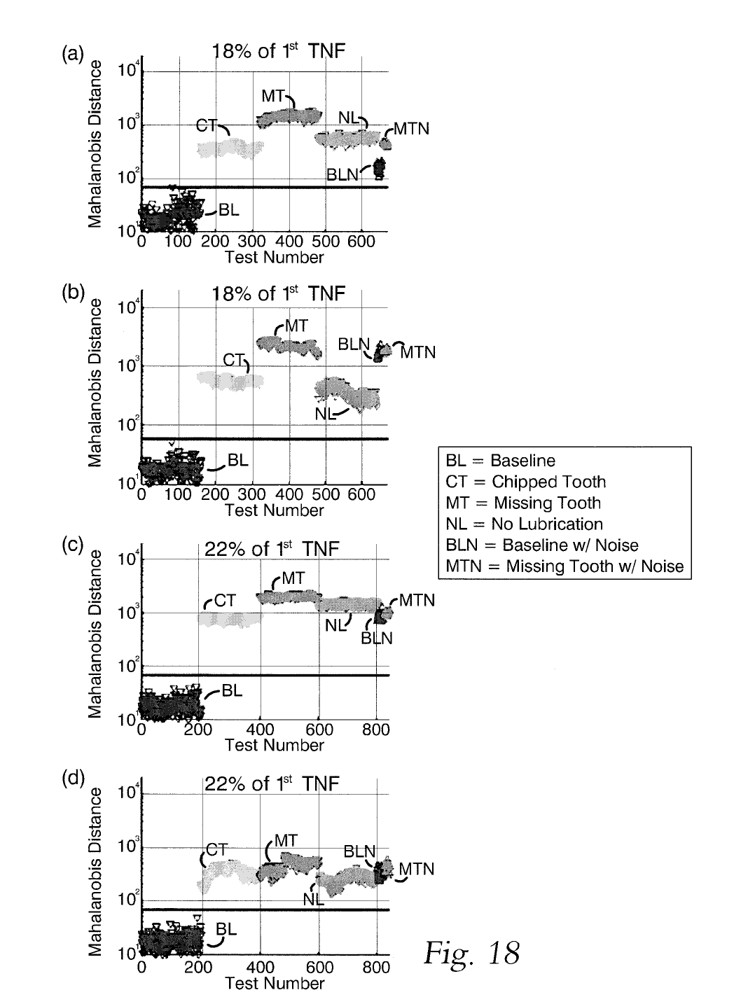

In order to train the model, half of the healthy data was used for the baseline data while the other half was used to validate the model and determine if any number of false indications of damage occurred. As can be seen from the plots of the Mahalanobis distances at each of the investigated frequencies shown in FIG. 18, no false indications of damage occurred, and all of the other operational conditions could be distinguished from the healthy data. FIG. 18 shows four Mahalanobis distance plots (marked a-d) generated using half of the healthy data as the baseline case. The significant difference threshold is indicated with a black horizontal line. Graphs (a) and (c) are generated from torque sensor data, and graphs (b) and (d) are generated from accelerometer data. The data is plotted on a log scale because of the large separation between the healthy data and the data from any of the other conditions.

It is important to note the effects of the external noise (as previously discussed above) on the Mahalanobis distance calculation. The resulting Mahalanobis distance from data for the baseline and missing tooth conditions with added external noise are presented in FIG. 18. Ideally, the baseline (or healthy) data with the external noise would fall within the threshold set by the healthy data, or at least this should be true for torque sensor which are not be significantly affected by external translational vibration on the gearbox housing. As can be seen in FIG. 18, this is not true. However, the baseline data with noise is closer to the threshold relative to the other data sets for the torque measurements than for the accelerometer measurements. This indicates the torque sensor's lower sensitivity to translational structure born noise compared to the use of an accelerometer on the gearbox housing.

Overall, the Mahalanobis distance analysis successfully separated the healthy and damaged data, except for 25 and 30 Hz shaft speeds. It is proposed that this result is due to the gear mesh frequency for input shafts speeds between 25 and 30 Hz being between the first two calculated TNFs, and therefore having a decreased signal to noise ratio. As previously described, a small test bench gearbox was used for the purposes of testing the methods presented as the exemplary embodiment of the broader invention. Therefore, because of the importance of the TNFs to the response, and the fact that both the TNFs and input shaft speeds of interest will decrease for larger gearboxes (e.g., wind turbine gearboxes), the data is labeled with the input shaft speed indicated as a percentage of the first torsional natural frequency, as indicated in FIGS. 17, 18, and 19.

While this process enabled the healthy condition to be distinguished from the unhealthy conditions, the process was unable to classify the type of damage. In order to facilitate this process, a two-step procedure was performed on the same data feature that was used for the previously described Mahalanobis distance procedure. Because this was a supervised learning process, half of the data from each condition was used as training data. Parzen discriminant analysis was then applied to the data. This analysis is a subspace projection method that makes no assumptions about the underlying distributions of the data. Instead, it investigates local regions around each data point and attempts to maximize the ratio of the average local scatter across dissimilar groups (S_{D}) to the average local scatter within each group (S_{S}). This is achieved by solving the generalized eigenvalue problem as follows:

$${S}_{D} x = λ {S}_{S} x$$

$${S}_{D} = \frac{1}{N} {\sum }_{i = 1}^{N} \frac{1}{{N}_{R ( {x}_{i} )}^{D}} {\sum }_{{{x}_{j} ∈ R ( {x}_{i} )}_{c ( {x}_{i} ) \neq c ( {x}_{j} )}} ( {x}_{i} - {x}_{j} ) {( {x}_{i} - {x}_{j} )}^{T}$$

$${S}_{S} = \frac{1}{N} {\sum }_{i = 1}^{N} \frac{1}{{N}_{R ( {x}_{i} )}^{S}} {\sum }_{{{x}_{j} ∈ R ( {x}_{i} )}_{c ( {x}_{i} ) = c ( {x}_{j} )}} ( {x}_{i} - {x}_{j} ) {( {x}_{i} - {x}_{j} )}^{T}$$

where N is the total number of data points, R(xᵢ) is the local region around xᵢ, N_{Rx}^{D} is the number of dissimilar samples in the region, and N_{Rx}^{S} is the number of samples in the region that are of the same class as xᵢ as indicated by c(xᵢ)=c(xⱼ). The rows of the optimal projection matrix for a selected number of dimensions is then composed of the eigenvectors corresponding the largest eigenvalues. For this investigation, the data was projected down to two dimensions to ease visualization and the local region around each point, R(xᵢ), was defined as a hypersphere around each point whose radius was equal to five times the average distance to the nearest neighbor.

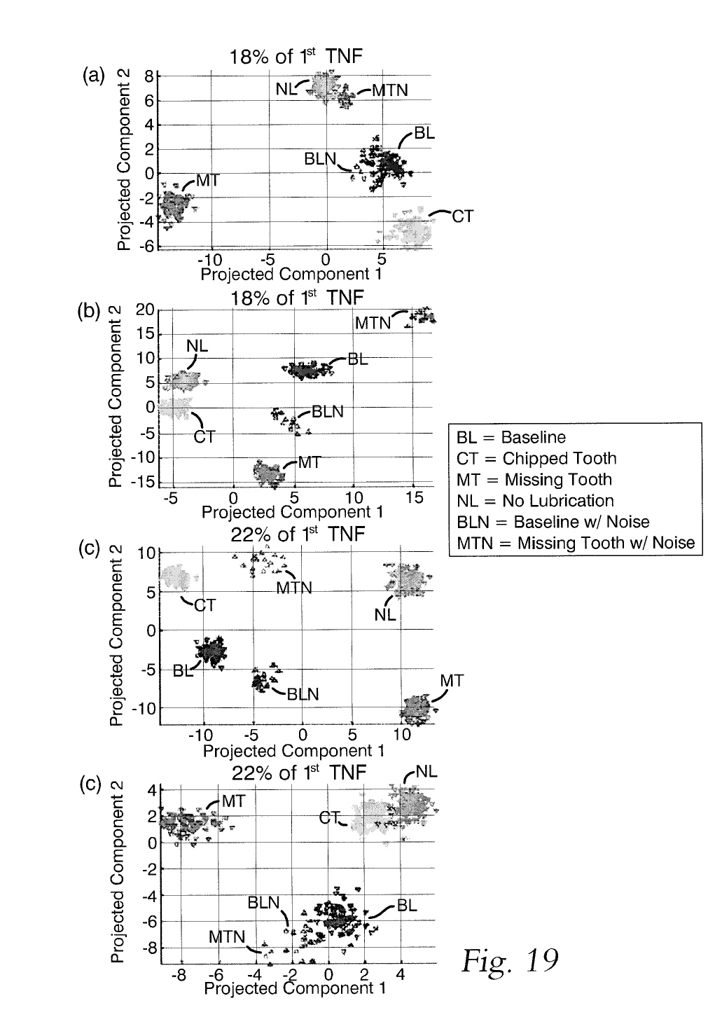

After the training data had been used to formulate the projection matrix described above, this matrix was then applied to the training data, after which linear discriminant analysis was performed on the projected data including data from the baseline and missing tooth condition with added external noise. This resulted in the correct classification of all testing data sets for the torque measurements without added external noise, as can be seen in the classification scatter plots shown in FIG. 19. FIG. 19 includes four graphs (marked a-d) of classification plots and boundaries generated using Parzen discriminant analysis to project the data into two, dimensions and linear discriminant analysis to classify the projected data. Graphs (a) and (c) are generated from the torque sensor data and graphs (b) and (d) are generated from the accelerometer data.

The different classes (without the added external noise) are well, clustered and separated at each of the input shaft speeds investigated for the torque data. However, the accelerometer data did not yield equally successful results at all operational speeds. For example, as can be seen in the graphs b and d of FIG. 19, the chipped tooth and no lube groups were not as distinct, which in turn led to several false classifications, and similar results were seen at other operating speeds. Finally, it is important to note the effects of the external noise on this analysis. The baseline data with added noise was successfully classified in the baseline group when torque data was used (see graphs a and c of FIG. 19). However, the accelerometer data was not as successful at certain speeds (e.g., graph b of FIG. 19). The missing tooth condition with the added external noise was not successfully classified using the torque or the accelerometer data, which points to the need for further analysis and experimentation regarding the classification process and the effects of external structure borne noise. Finally, it should also be noted that simply applying linear discriminant analysis to the raw data or to the first several principal components failed to correctly classify all of the data sets, which in turn shows the utility of the nonparametric discriminant analysis.

As indicated above, a simple two-stage spur gear bench test was used as the exemplary embodiment for validation of the adeptness of torque transducer measurements in detecting drivetrain component faults. The numerical model was first shown to be capable of simulating the operational response measured by the torque transducer, and could be updated for simulation of drivetrain conditions of interest, knowing the condition's effect on the system properties. It has been shown through statistical methods and experimentation that a torque transducer is capable of detecting both drivetrain faults, namely chipped and missing teeth, and precursors to faults, namely misalignment and lack of lubrication. This could be useful in applications (such as a wind turbine geartrain) plagued with frequent gear failures, where detection of fault precursors is necessary to circumnavigate absolute failure. Through the application to multiple data sets of known conditions or faults, this method could be trained for use in any application. The torque sensor was additionally shown to be highly sensitive to low frequency vibrations due to misalignment and insensitive to ambient noise introduced to the gearbox housing, a noted advantage over accelerometers for use in gear trains which operate in dynamic environments. The findings set forth herein certainly seem to point to several advantages of the utilization of a torque sensor mounted to the driveline over accelerometers mounted to the gearbox housing in gearbox fault diagnostics, thereby providing for the utilization of alternative damage detection and classification methods.

An abundance of different damage detection and classification methods could be applied to the torque waveform in order to develop and apply different embodiments of the invention. While the previously described example utilized specific methods for the detection and classification of damage utilizing torque waveforms, it should be apparent to those having ordinary skill in the art that that there are a plethora of different algorithms that could be applied to the torque waveforms in order to obtain and classify damage features. The previously described algorithms have been used as an example of the utility of torque waveforms in damage detection and therefore should not be viewed as a limitation of the method.

While the present invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that they feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method for detecting a fault condition in a drivetrain, comprising:
monitoring torque oscillations at a location along a drivetrain; and
detecting at least one fault condition associated with a drivetrain component by evaluating torque oscillation data acquired during the monitoring.

2. The method of claim 1, wherein the torque oscillation data is characterized as a torque waveform having at least one peak amplitude corresponding to the at least one fault condition associated with the drivetrain component.

3. The method of claim 1, further comprising:
generating simulated torque data associated with the drivetrain component that simulates dynamic behavior of the drivetrain component; and
wherein the detecting comprises comparing the torque oscillation data to the simulated torque data to identify the at least one fault condition associated with the drivetrain component.

4. The method of claim 3, wherein the simulated torque data is generated from a physics-based analytical model that simulates dynamic behavior of the drivetrain.

5. The method of claim 3, wherein the simulated dynamic behavior of the drivetrain component includes:
a normal operating condition of the drivetrain component; and
the at least one fault condition associated with the drivetrain component.

6. The method of claim 3, wherein the torque oscillation data is characterized as a torque waveform; and
wherein the detecting comprises comparing the torque waveform to the simulated torque data to identify the at least one fault condition associated with the drivetrain component.

7. The method of claim 3, wherein the simulated torque data is characterized at multiple frequencies to identify the at least one fault condition associated with the drivetrain component at multiple operating speeds of the drivetrain.

8. The method of claim 3, further comprising:
characterizing the torque oscillation data into identifiable operational features;
characterizing the simulated torque data into identifiable simulated features; and
comparing the identifiable operational features to the identifiable simulated features to detect the at least one fault condition associated with the drivetrain component.

9. The method of claim 1, wherein the at least one fault condition associated with the drivetrain component comprises at least one of an actual drivetrain component fault and at least one of a precursor to a drivetrain component fault.

10. The method of claim 9, wherein the detecting comprises identifying a chipped gear tooth condition or a missing gear tooth condition associated with the drivetrain component using the torque oscillation data acquired during the monitoring.

11. The method of claim 9, wherein the detecting comprises identifying a misalignment condition associated with the drivetrain component using the torque oscillation data acquired during the monitoring.

12. The method of claim 9, wherein the detecting comprises identifying a lack of lubrication condition associated with the drivetrain component using the torque oscillation data acquired during the monitoring.

13. The method of claim 1, wherein the monitoring of the torque oscillations comprises sensing torque levels using a torque transducer at the location along the drivetrain.

14. The method of claim 1, wherein the drivetrain component comprises a gearbox that forms part of either a wind turbine or a gas turbine engine.

15. A method for detecting a fault condition in a drivetrain, comprising:
generating simulated torque data associated with the drivetrain component that simulates dynamic behavior of the drivetrain component;
monitoring measured torque at a location along the drivetrain; and
comparing the measured torque to the simulated torque data to identify at least one fault condition associated with the drivetrain component.

16. The method of claim 15, wherein the simulated torque data is generated from a physics-based analytical model that simulates dynamic behavior of the drivetrain.

17. The method of claim 15, wherein the simulated dynamic behavior of the drivetrain component comprises:
a normal operating condition of the drivetrain component; and
the at least one fault condition associated with the drivetrain component.

18. The method of claim 15, wherein the simulated torque data is characterized at multiple frequencies to identify the at least one fault condition associated with the drivetrain component at multiple operating speeds of the drivetrain.

19. The method of claim 15, further comprising:
characterizing the measured torque into identifiable operational features;
characterizing the simulated torque data into identifiable simulated features; and
comparing the identifiable operational features to the identifiable simulated features to detect the at least one fault condition associated with the drivetrain component.

20. The method of claim 15, wherein the monitoring of the measured torque comprises monitoring torque oscillations at the location along the drivetrain.

21. The method of claim 20, wherein the torque oscillations are characterized as a torque waveform; and
wherein the comparing comprises comparing the torque waveform to the simulated torque data to identify the at least one fault condition associated with the drivetrain component.

22. The method of claim 20, wherein the torque oscillations are characterized as a torque waveform having a peak amplitude corresponding to the at least one fault condition associated with the drivetrain component.

23. The method of claim 15, wherein the simulated torque data is characterized at multiple frequencies to identify the at least one fault condition associated with the drivetrain component at multiple operational speeds of the drivetrain.

24. The method of claim 15, wherein the at least one fault condition comprises at least one of a chipped gear tooth condition and a missing gear tooth condition associated with the drivetrain component.

25. The method of claim 15, wherein the fault condition comprises at least one of a misalignment condition associated with the drivetrain component and a lack of lubrication condition associated with the drivetrain component.

26. A system for detecting a fault condition in a drivetrain, comprising:
a torque sensor coupled to a drivetrain component, the torque sensor configured to measure torque at a location along the drivetrain and to generate a torque oscillation signal corresponding to the measured torque; and
a controller configured to receive the torque oscillation signal and evaluate the torque oscillation signal to identify at least one fault condition associated with the drivetrain component.

27. The system of claim 26, further comprising a physics-based analytical model that simulates dynamic behavior of the drivetrain, the physics-based analytical model providing a simulated torque data set associated with the drivetrain component; and
wherein the controller is configured to compare the torque oscillation signal with the simulated torque data set to identify the at least one fault condition associated with the drivetrain component.

28. The system of claim 26, wherein the torque oscillation signal comprises a torque waveform having at least one peak amplitude corresponding to the at least one fault condition associated with the drivetrain component.

29. The system of claim 26, wherein the at least one fault condition comprises at least one of a chipped gear tooth condition and a missing gear tooth condition.

30. The system of claim 26, wherein the at least one fault condition comprises at least one of a misalignment condition and a lack of lubrication condition.
